(19) United States
(12) Patent Application Publication
(10) Pub. No.: US 2021/0370617 A1
(43) Pub. Date: Dec. 2, 2021

(54) SYSTEM AND METHOD FOR VACUUM ACTUATED THERMOPLASTIC COMPOSITE WELDING

(71) Applicant: Spirit AeroSystems, Inc., Wichita, KS (US)

(72) Inventor: Mark Anthony Wadsworth, Sedan, KS (US)

(73) Assignee: Spirit AeroSystems, Inc., Wichita, KS (US)

(21) Appl. No.: 16/886,862

(22) Filed: May 29, 2020

(51) Int. Cl. B29C 65/00; B29C 65/02

(52) U.S. Cl. CPC B29C 66/8145; B29C 66/721; B29C 65/02

(57) ABSTRACT

A system using a pressure differential to clamp welding heads on opposite sides of a joint of a thermoplastic composite structure to be welded. The heads are positioned over the joint opposite each other. Each head includes a housing defining a chamber having a lower pressure such that the pressure differential forces the head against the side. Each head includes a contour plate located in the space and against the joint, and at least one of the heads includes a heater located in the space and heating the contour plate to a welding temperature. The system may also include a first arm coupled with one of the heads and moving it along the joint so as to remain aligned with the other head, and a second arm coupled with the other head and moving it along the joint while the system welds the joint in successive overlapping sections.

### FIELD

The present invention relates to systems and methods for welding thermoplastic composite structures, and more particularly, embodiments concern a system employing a pressure differential to secure welding heads on opposite sides of a joint of a structure to be welded.

### BACKGROUND

It is sometimes desirable to weld large joints in large thermoplastic composite structures. For example, constructing aircraft fuselages often involves joining fuselage sections, and thermoplastic composite welding is stronger and more reliable than adhesive bonds. However, joining methods are a weak link in the manufacture of composite structures. Conventional conduction welding might be used, but wide joints may produce much higher forces than a robot can react for even a six inch weld. Further, the distance to the nearest opening through which a robot could be cantilevered may exceed twelve feet, so a deep-throated yoke would be very heavy and unwieldy.

This background discussion is intended to provide information related to the present invention which is not necessarily prior art.

### SUMMARY

Embodiments provide a system employing a pressure differential to clamp welding heads on opposite sides of a joint of a thermoplastic composite or other structure to be welded. Applications include manufacturing aircraft fuselages and other vehicle bodies and substantially any other application involving long and wide welds with relatively little or no axial contour.

In one embodiment, a system is provided for welding a joint of a structure. The system may comprise a first welding head and a second welding head. The first welding head may be positioned over the joint on a first side of the structure, and may comprise a first housing and a first contour plate. The first housing may define a first chamber between the first housing and the first side, and the first chamber may comprise a first lower pressure than atmospheric pressure such that atmospheric pressure forces the first welding head against the first side. The first contour plate may be located in the first chamber and may compress the joint on the first side. The second welding head may be positioned over the joint opposite the first welding head on a second side of the structure, and may comprise a second housing, a second contour plate, and a heater. The second housing may define a second chamber between the second housing and the second side, and the second chamber may comprise second lower pressure than atmospheric pressure such that atmospheric pressure forces the second welding head against the second side. The second contour plate may be located in the second chamber and may compress the joint on the second side. The heater may be located in the second chamber and may heat the second contour plate to a welding temperature to weld the joint.

Various implementations of the foregoing embodiment may include any one or more of the following additional features. The structure may be a thermoplastic composite structure. The first lower pressure may be no more than five percent different from the second lower pressure. The first contour plate may have a different area than the second contact plate. The first contour plate may be smaller by a first factor than the first housing so that the first pressure differential forces the first contour plate against the joint with a first force that is greater than atmospheric pressure, and the second contour plate may be smaller by a second factor than the second housing so that the second pressure differential forces the second contour plate against the joint with a second force that is greater than atmospheric pressure. The system may include another heater located in the first chamber and heating the first contour plate to the welding temperature. A first splice piece may be located in the first chamber and positioned between the joint and the first contour plate and welding to the first side over the joint, and a second splice piece may be located in the second chamber and positioned between the joint and the second contour plate and welding to the second side over the joint. An aligner may align the first and second housings on opposite sides of the structure.

A first compressible seal may maintain the first lower pressure in the first chamber, and a second compressible seal may assist in maintain the second lower pressure in the second chamber. A first landing pad may extend between the first housing and the first side of the structure and reduce deformation of the structure, and a second landing pad may extend between the second housing and the second side of the structure and reducing deformation of the structure. An actuator may be moveable between a first position in which the actuator exerts a force on an end of the first landing pad, and a second position in which the actuator does not exert the force on the end of the first landing pad. A first vacuum connection may be located on the first housing and connected to a vacuum source to create the first lower pressure in the first chamber, and a second vacuum connection may be located on the second housing and connected to the vacuum source to create the second lower pressure in the second chamber.

A first heat sink may be located in the first chamber and in physical contact with the first side to remove heat from the first side, and a second heat sink may be located in the second chamber in physical contact with the second side to remove heat from the second side. A first insulation spacer may be located in the first chamber and control a transfer of heat from the first heater, and a second insulation spacer may be located in the second chamber and control a transfer of heat from the second heater. A first transfer bar may be located in the first chamber and extend between the first housing and first contour plate and transfer a force of the first pressure differential to the first contour plate, and a second transfer bar may be located in the second chamber and extend between the second housing and second contour plate and transfer a force of the second pressure differential to the second contour plate.

A first vacuum regulator may be coupled with the first chamber and may independently control the first lower pressure, and a second vacuum regulator may be coupled with the second chamber and may independently control the second lower pressure. A first actuator may extend between the first housing and the first contour plate and may selectively advance and withdraw the first contour plate relative to the first side of the structure, and a second actuator may extend between the second housing and the second contour plate and may selectively advance and withdraw the second contour plate relative to the second side of the structure. A first arm may be coupled with the first welding head and may move the first welding head along the joint so as to remain aligned with the second welding head, and a second arm may be coupled with the second welding head and may move the second welding head along the joint, wherein the system welds the joint in successive overlapping sections.

This summary is not intended to identify essential features of the present invention, and is not intended to be used to limit the scope of the claims. These and other aspects of the present invention are described below in greater detail.

### DRAWINGS

Embodiments of the present invention are described in detail below with reference to the attached drawing figures, wherein:

FIG. 1 is a fragmentary cross-sectional elevation view of a first embodiment of a system using a pressure differential to clamp welding heads on opposite sides of a joint of a structure to be welded;

FIG. 2 is a fragmentary cross-sectional elevation view of an implementation of the system of FIG. 2, wherein an actuator component is shown in a first position;

FIG. 3 is a fragmentary cross-sectional elevation view of an implementation of the system of FIG. 2, wherein the actuator component is shown in a second position;

FIG. 4 is a fragmentary cross-sectional elevation view of an implementation of the system of FIG. 2, wherein a number of sensors and control components are employed;

FIG. 5 is a fragmentary cross-sectional elevation view of an implementation of the system of FIG. 2, wherein welding components are shown withdrawn and the actuator component is shown in a second position for evaluating the welded joint of the structure;

FIG. 6A is a fragmentary cross-sectional elevation view of a implementation of the system of FIG. 2 configured for use in an example application, wherein the system is coupled with robots or other movers for moving the system along the joint of the structure;

FIG. 6B is a side elevation view of the system of FIG. 6A;

FIG. 6C is a fragmentary cross-sectional plan view of the system of FIG. 6A;

FIG. 6D is a side elevation view of one welding head component of the system of 6A showing multiple contour plate components configured to provide a substantially continuous surface along a length of the joint of the structure;

FIG. 7 is a fragmentary perspective depiction of the system of FIG. 2 configured to be supported through an end opening in the structure while moving along the joint of the structure;

FIG. 8 is a fragmentary perspective depiction of the system of FIG. 2 configured to independently support each welding head on opposite sides of the structure while moving along the joint of the structure;

FIG. 9 is a fragmentary perspective depiction of the system of FIG. 2 configured to be supported through side openings in the structure while moving along the joint of the structure; and

FIG. 10 is a flowchart of steps in an embodiment of a method of using a pressure differential to clamp welding heads on opposite sides of a joint of a thermoplastic composite structure to be welded, wherein the method reflects the operation of the system of FIGS. 1-8.

The figures are not intended to limit the present invention to the specific embodiments they depict. The drawings are not necessarily to scale.

### DETAILED DESCRIPTION

The following detailed description of embodiments of the invention references the accompanying figures. The embodiments are intended to describe aspects of the invention in sufficient detail to enable those with ordinary skill in the art to practice the invention. Other embodiments may be utilized and changes may be made without departing from the scope of the claims. The following description is, therefore, not limiting. The scope of the present invention is defined only by the appended claims, along with the full scope of equivalents to which such claims are entitled.

In this description, references to “one embodiment,” “an embodiment,” or “embodiments” mean that the feature or features referred to are included in at least one embodiment of the invention. Separate references to “one embodiment,” “an embodiment,” or “embodiments” in this description do not necessarily refer to the same embodiment and are not mutually exclusive unless so stated. Specifically, a feature, component, action, step, etc. described in one embodiment may also be included in other embodiments, but is not necessarily included. Thus, particular implementations of the present invention can include a variety of combinations and/or integrations of the embodiments described herein.

Broadly, embodiments provide a system using a pressure differential to secure welding heads on opposite sides of a joint of a thermoplastic composite or other structure to be welded. In one implementation, the heads may be positioned over the joint on opposite sides of the structure. Each welding head may include a housing defining a chamber having a lower pressure such that a pressure differential forces the welding head against the side of the structure. Each welding head may further include a contour plate located in the chamber and against the joint, and one or both of the welding heads may include a heater located in the chamber and heating the contour plate to a welding temperature to weld the joint. In one implementation, the pressure differentials may be used to create pre- or post-weld loading on the joint as desired or necessary to cancel deformations induced by welding and/or to proof-load the joint to test the weld. In one implementation, the system may further include a first arm coupled with one of the welding heads and moving it along the joint so as to remain aligned with the opposing welding head, and a second arm coupled with the other welding head and moving it along the joint while the system welds the joint in successive overlapping sections.

Embodiments provide a number of advantages over the prior art, including that geometric vacuum intensification, which is achieved by transferring the force of the pressure differential to the contour plates, allows for accommodating a pressure of greater than one bar as desired or needed to produce welds of consistent quality. Further, the opposing welding heads on each side of the structure cancel the vacuum pressure loads on the joint and eliminate the need for achieving or maintaining vacuum integrity through the thickness of the structure. Additionally, when two heaters are used to heat the structure through from opposite sides rather than heating it through from one side, less heat is needed on each side, which advantageously reduces the time required to perform the weld, the amount of heat migrating into areas surrounding the weld, and the surface temperature of the laminate. Additionally, closed loop control over heating from both sides allows for better control over the melt pattern in the joint, and simplifies achieving a smooth face on one of the sides. Additionally, welding in reduced pressure advantageously reduces the amount of air in the joint, both by removing the air and by applying compression to force the air out, thereby resulting in a higher quality joint.

Applications include manufacturing aircraft fuselages and other vehicle bodies and substantially any other application involving long and wide welds with relatively little or no axial contour.

The second housing may be aligned opposite the first housing by any of a variety of aligners including a yoke mounting, magnetic or proximity detectors, or a metrology sensor of any of various types. For example, a Hall effect sensor may be used to sense proximity to a magnet, a magnetometer may be used to determine proximity to a metallic protrusion, or a magnetometer array chip may be used to provide directional prompting during the alignment process rather than just a binary indication that the two sides either are or are not adequately aligned.

Once the two housings are aligned, the absolute pressure in each may be lowered from a position-securing range to the process range, and depending on the positions of the landing pads, the accumulated pressure differential force may be transferred to the contour plates. Because the contour plates may have substantially less area than the housing within the perimeter seal, the pressure differential force may be intensified.

The weld, or remelting of the laminate, may occur under the contour plates with one face that matches the contour of the desired joint and the opposing face in contact with a heater. Alternatively, the contour plate may be directly heated using induction, radiation, or joule heating. At the welding temperature, the joint may be compressed under the intensified pressure of the pressure differential force as the bypassed load is transferred to the contour plates, providing contact for fusion between the faying laminate or splice plies and forming a quality joint.

In one implementation, the contour plates may be adjustable to allow for over- or under-travel. Feedback and control of the position of both contour plate displacements and the relative positions between each other and the housings enables one side to have a lower deviation from the desired contour even if insufficient or excessive material exists in the joint to result in a zero void laminate that is flush to the surrounding laminate on both sides. This may compensate for differences between the accumulated joint ply thickness and the surrounding laminate thicknesses which would otherwise result in over- or under-compaction of the joint and associated defects. The ability to control which surface is flush allows for a weld that minimizes flow disruption or other disadvantageous conditions on a selected side that would otherwise require reworking.

The heater may be backed by insulation to minimize heat loss, and may be surrounded on some or all sides by a heat sink made from a thermally diffusive material which may be laminated from thin strips or machined to match the contours, and which may be held in contact with the structure and/or joint by springs; electric, hydraulic or pneumatic arms; or mechanical levers; or other biasing mechanisms to maintain contact while allowing movement independent of the contour plate. The heat sinks may prevent melting outside the weld zone and may be actuated separately, and may have enhanced compliance in order to maintain the necessary contact for effective heat transfer with a surface that may have undulations and not melt during the welding process. In one implementation, holes may be provided in the insulation to accommodate force transfer bars which allow the chamber pressure from the housing to be either transferred to the contour plate or bypassed into landings.

Landing pads may exert opposing forces against the sides of the structure to reduce deformation or delay the application of pressure until after the contour plates are heated. The forces exerted by the landing pads may be controlled using wedges, cams, screwjacks, brakes, or other actuators. The joint may experience relatively little or no loading when the pressure levels are equal in both chambers and the bypass landings are aligned such that when the force is bypassed into these landing pads the compression forces pass directly through the panel without producing a bending moment. In one implementation, swivel bases may be provided on some or all of the landing pads to reduce the compressive stress and enable adjustability of the landing arms.

In the event that asymmetry or other thermal expansion conditions in the splice material would result in a distorted joint configuration after cool-down, the joint may be exposed to a distributed load or other predictable stress condition prior to welding or during the melt process to compensate for the joining stresses. Additionally, a differential pressure between the chambers could be used to apply a biasing force to the contour plates after welding and, combined with a displacement measurement system, could proof load the joint after completion so that defective welds can be identified and repaired while the welding system is still in place.

The lower pressure in each chamber vacuum may be maintained across a perimeter seal that either extends to the end of the joint, where it can be sealed to its opposing counterpart, or has a secondary chamber on the two ends that cross the joint to act as a scavenging area where a high volume pump may evacuate the leakage through the unwelded section on either side of the welding zone.

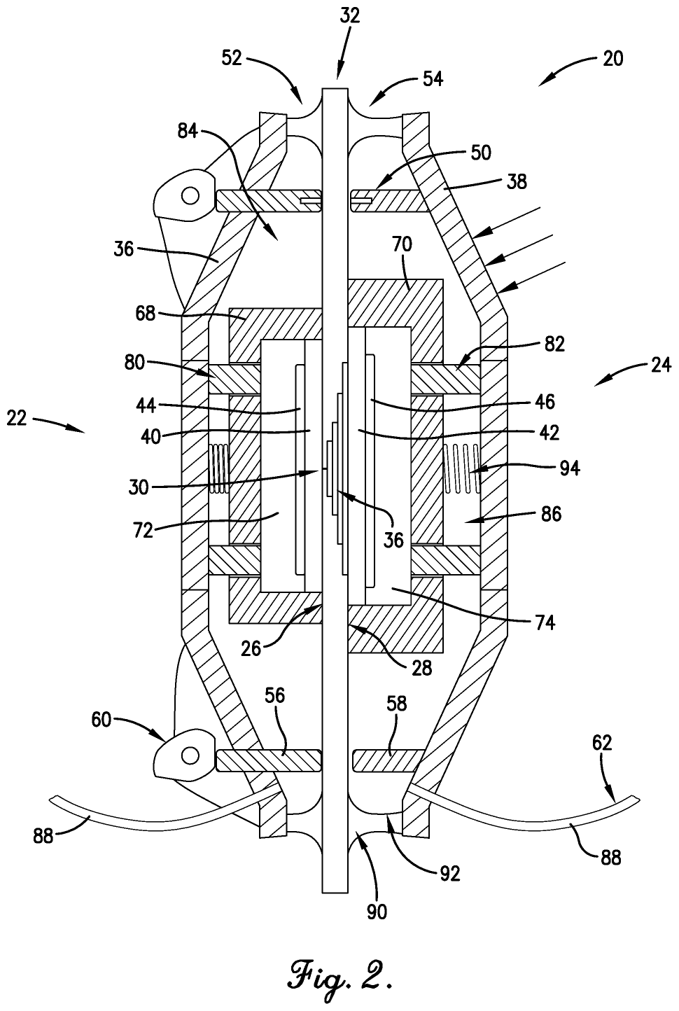

Referring to the figures, an embodiment of a system 20 is shown using a pressure differential to secure welding heads 22,24 on opposite sides 26,28 of a joint 30 of a thermoplastic composite or other structure 32 to be welded. The structure 32 to be welded may include the two sides 26,28, which may be a first or inner mold line (IML) side 26 and a second or outer mold line (OML) side 28, and the joint 30. In one application, the structure 32 may be an aircraft fuselage or other vehicle body, and may be approximately between one-quarter inch and one inch in thickness at the joint 30. In one implementation, seen in, e.g., FIG. 2, splice pieces 36 may be configured to be applied over the joint 30 on one or both sides 26,28 of the structure 32 so as to bridge the joint 30 and strengthen the weld.

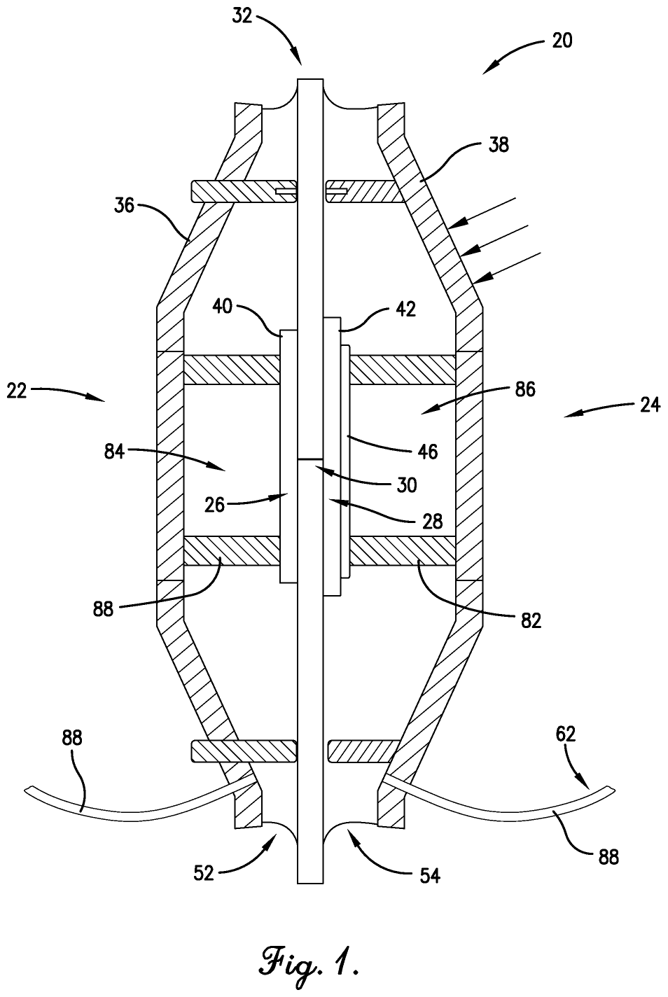

The system 20 may include the first and second welding heads 22,24, wherein, during welding, the first welding head 22 is positioned over the joint 30 and, if present, a splice piece 36 on the IML side 26 of the structure 32, and the second welding head 24 is positioned over the joint 30 and, if present, a splice piece 36 on the OML side 28 of the structure 32. In one implementation, the first and second welding heads 22,24 may include, respectively, first and second housings 36,38 and first and second contour plates 40,42. In one implementation seen in FIG. 1, the second welding head 24 may further include a heater 46, while in another implementation seen in FIG. 2, the first welding head may include a first heater 44 and the second welding head may include the second heater 46. In various implementations, the system 20 and/or the welding heads 22,24 may further include one or more aligners 50; first and second compressible seals 52,54; first and second landing pads 56,58; one or more actuators 60; a vacuum source 62; first and second heat sinks 68,70; first and second insulation spacers 72,74; and first and second force transfer bars 80,82.

Each of the first and second housings 36,38 may be configured to be positioned over the joint 30 on a respective side 26,28 of the structure 32, and to define, respectively, first and second chambers 84,86 between the housings 36,38 and the sides 26,28 of the structure 32. As described below in greater detail, during operation the first and second chambers 84,86 have, respectively, first and second lower pressures which are relatively lower than atmospheric pressure, such that the pressure differentials force the welding heads 22,24 against their respective sides 26,28. If the first and second chambers 36,38 are not in pressure communication, the respective lower pressures may not be equal, as discussed below.

In one implementation, each housing may define a single chamber, while in alternative implementations, one or both of the housings may define multiple chambers, and further, the pressure of each such chamber may be independently adjustable. In an example of the latter implementation, lower pressure may be maintained in spaces adjacent to the actual welders, and the welders may operate in atmospheric pressure. In one implementation, seals may be used to define additional spaces at the edges of the housings or the individual chambers where leakage is most likely.

Each of the first and second contour plates 40,42 may be configured to apply a force to the joint 30 and, if present, the splice pieces 36 such that the splice pieces 36 are substantially flush with the surfaces of the respective sides 26,28 of the structure 32, and to distribute heat from the heaters 44,46 across the weld zone. In one implementation, the second contour plate 42 may slightly embed the splice piece 36 into the OML surface 28 in order to compact voids. In one implementation, the first and second contour plates 40,42 may have different dimensions in order to better control weld area and pressure distribution. For example, the second contour plate 42 on the OML side 28 of the structure 32 may have a larger area than the first contour plate 40 so that pressure is applied over a larger area in order to achieve a smoother surface. In one implementation, a pressure intensification feature may be employed and controlled in that the first contour plate 40 may be made smaller by a particular first factor than the first housing 36 so that the first pressure differential forces the first contour plate 40 against the joint 30 with a known first force (e.g., approximately two bars of pressure, or approximately between two and five bars of pressure) that is greater than atmospheric pressure, and the second contour plate 42 may be made smaller by a particular second factor than the second housing 38 so that the second pressure differential forces the second contour plate 42 against the joint 30 with a known second force (e.g., approximately two bars of pressure, or approximately between two and five bars of pressure) that is greater than atmospheric pressure.

Each of the first and second heater 44,46 may be configured to raise the temperature of the respective contour plates 40,42 to the weld temperature. In one implementation, the contour plates 40,42 may be evenly heated across their surfaces. In another implementation, the contour plates 40,42 may be heated to a higher temperature in an area closer to the joint 30, and may be heated to a lower temperature in an area further from the joint 30. In the latter implementation, the heat sinks 68,70 may be eliminated due to decreased transfer of heat to the surrounding structure outside of the weld zone. As discussed, in one implementation, seen in FIG. 1, there may be a heater in only one welding head, while in another implementation, seen in, e.g., FIG. 2, there may be heaters in both welding heads.

The aligner 50 may be configured to assist in aligning the first and second housings 36,38 on opposite sides 26,28 of the structure 32. In one implementation, the aligner 50 may take the form of a magnet associated with one housing and a reed switch associated with the other housing to provide an indication of when the housings are aligned. In the figures, the aligner 50 is shown incorporated into landing pads, but in other implementations, the aligner may be incorporated into other features or may stand alone. The first and second compressible seals 52,54 may be configured to substantially seal the respective housings 36,38 against the sides 26,28 of the structure 32 so that the lower pressures can be better created and maintained within the chambers 84,86.

The first and second landing pads 56,58 may be configured to react the vacuum force into the actuators 60 to reduce distortion of the joint 30. The first landing pads 56 may extend between the first housing 36 and the first side 26 of the structure 32, and may cooperate with the second landing pads 58 to reduce or prevent deformation of the structure 32. In implementations, the first landing pads 56 may be fixed or adjustable structures extending from or through the first housing 36 to the IML side 26 of the structure 32 to reduce or prevent housing motion in the OML direction. The second landing pads 58 may extend between the second housing 38 and the second side 28 of the structure 32 opposite the first landing pads 56, and may cooperate with the first landing pads 56 to reduce or prevent deformation of the structure 32. In implementations, the second landing pads 58 may be fixed or adjustable structures extending from or through the second housing 38 to the OML side 28 of the structure 32 to reduce or prevent housing motion in the IML direction. In one implementation, the ends of the landings pads in contact with the sides of the structure may be provided with ball joint pads to enable higher reaction capability.

The one or more actuators 60 may be associated with one or more of the landing pads 56,58 and configured to actuate so as to adjust one or more of the landing pads 56,58 to selectively contact and exert adjustable force against one or both of the sides 26,28 of the structure 32. The actuators 60 may take the form of any suitable selectively extendable and retractable technology, such as cams, screwjacks, brakes, cylinders, etc. Further, in one implementation the actuators may have two or more discrete positions, while in another implementation the actuators may be continuously adjustable. Alternatively, the actuators may be replaced by a pressure/vacuum regulator to modulate the pressures and the timing of the pressures in the chambers to adjust the force of the landings pads against the sides of the structure, thereby achieving a similar effect as the actuators.

The vacuum source 62 may be configured to create and maintain the first and second lower pressures in the respective first and second chambers 84,86 defined by the housings 36,38 and the sides of the structure 32. In one implementation, the vacuum source 62 may include vacuum lines 88 connected to the chambers 84,86. Leaks, including leaks through the unwelded joint, may be compensated with a volume pump. In one implementation, a minimum of approximately two thousand pounds per square foot of pressure may be achieved without an external clamping reaction. As mentioned, it will be appreciated that the first and second lower pressures in each chamber 84,86 may not be identical for various reasons, and so in various implementations, the pressure may be no more than approximately ten percent different from each other, no more than approximately five percent different from each other, or no more than approximately one percent different from each other depending on the application. In one implementation, one or both housings 36,38 may be associated with or include scavenger chambers 90 and labyrinth seals 92 to limit leakage. Further, a stronger vacuum using a high volume pump may be applied at the edges of one or both the housings 36,38 when leakage is most likely. Welding in reduced pressure advantageously reduces the amount of air in the joint 30, both by removing the air and by applying compression to force the air out, thereby resulting in a higher quality joint. In one implementation, welding may occur with a lowered pressure that results in the contour plates 40,42 exerting approximately one bar of pressure on each side of the structure 32, or approximately two bars of pressure, or approximately between two and five bars of pressure.

In one embodiment, the vacuum source may be replaced or supplemented with electromagnets, wherein the electromagnetic attraction between electromagnets on opposite sides of the structure is automatically and/or manually controlled to achieve substantially the same effects as the pressure differential with regard to forcing the welding heads against the sides 26,28 of the structure 32.

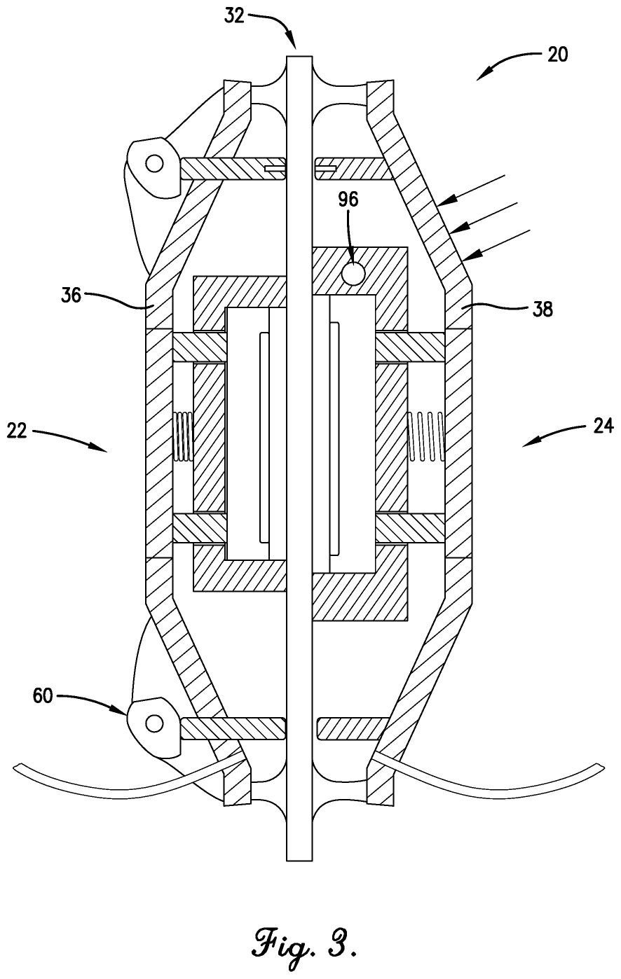

Each of the first and second heat sinks 68,70 may be configured to reduce or prevent melting outside of the weld zone. The heat sinks 68,70 may be in physical contact with the surfaces of the structure 32 in order to remove heat therefrom. In one implementation, springs; electric, hydraulic or pneumatic arms; or mechanical levers; or other biasing mechanisms 94 may assist in maintaining the heat sinks 68,70 in contact with the respective sides 26,28 of the structure 32. As seen in FIG. 3, in one implementation, cooling channels 96 may be provided in the heat sinks 68,70 to assist in removing the heat of welding. Each of the first and second insulation spacers 72,74 may be configured to control the application of heat from the heaters 44,46 and/or to reduce the transfer of heat outside of the welding zone. Each of the first and second force transfer bars 80,82 may be configured to transfer the forces of the pressure differentials acting on the respective housings 36,38 to the contour plates 40,42 so that the contour plates 40,42 exert the forces against the sides of the structure 32. In one implementation, some or all of the force transfer bars 80,82 may have adjustable lengths to change the contact point and/or force or to release the force without releasing the lower pressures during validation.

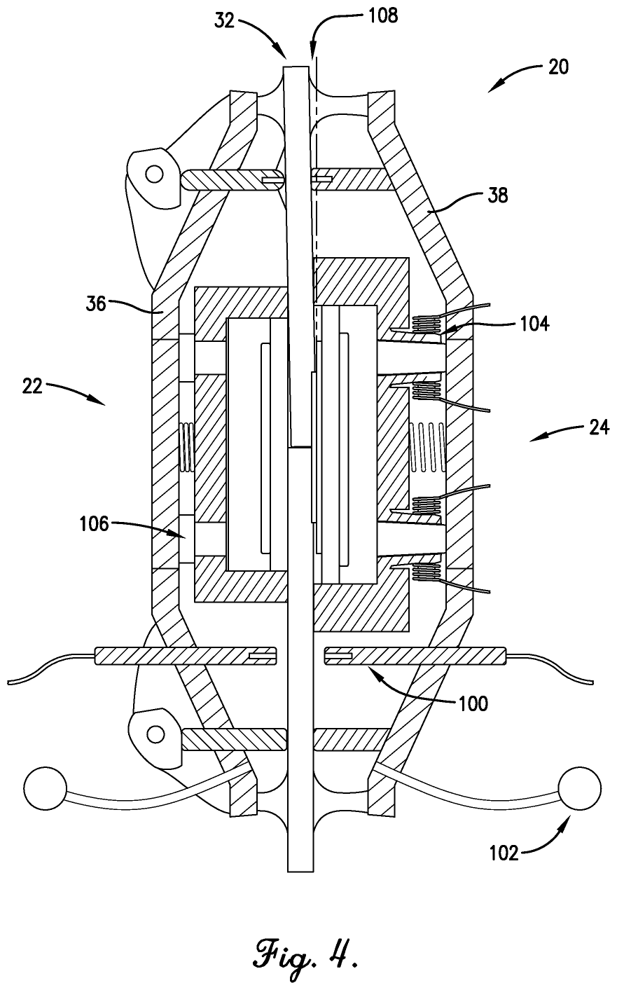

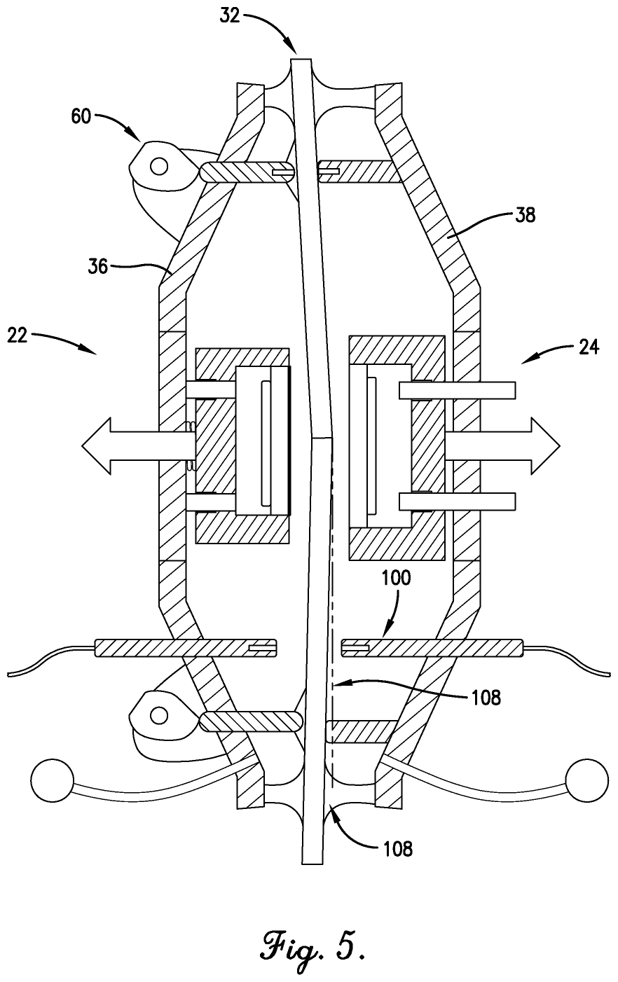

Referring also to FIG. 4, in various embodiments one or more of the following sensors or controls may be included in the system. One or more sensors 100 may sense relative surface locations from one or both of the housings 36,38 and along the length so as to detect distortion in the structure 32. One or more vacuum regulators 102 may alter the first and second lower pressures on opposite sides of the structure 32 in order to preload or deload the structure 32 during welding or annealing. In one implementation, this feature may be used to compensate for asymmetry in a weld section that could result in surface inflections. One or more brakes 104 may lock one heat sink 68,70 to its respective housing 36,38 at an appropriate distance for flush welding on one of the sides 26,28. One or more stops 106 may limit force transfer in order to control the depth of one or both contour plates 40,42. In one implementation, this feature may be used in combination with the landing pads 56,58 to create an induced moment. Flexure in or distortion 108 of the structure 32 for post-weld inspection and/or verification may be directly caused by mechanical impingement or by induced differential pressure in the chambers 84,86. As seen in FIG. 5, the actuators 60 may be configured to retract welding features in order to enable free pressure weld validation by load/deflection measurements. This feature may be particularly useful on the continuous full length weld implementation discussed below.

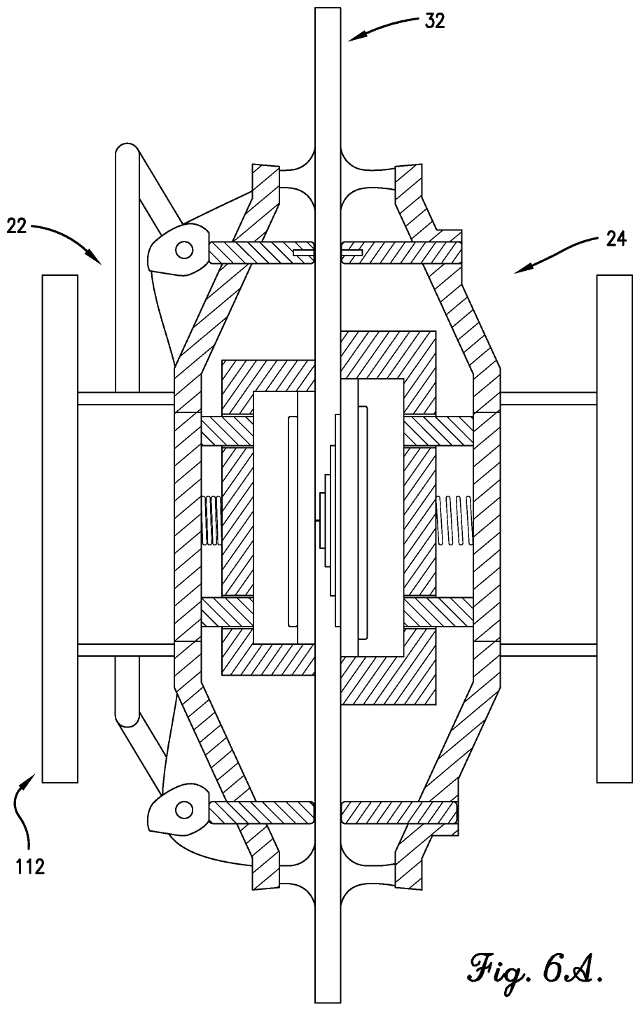

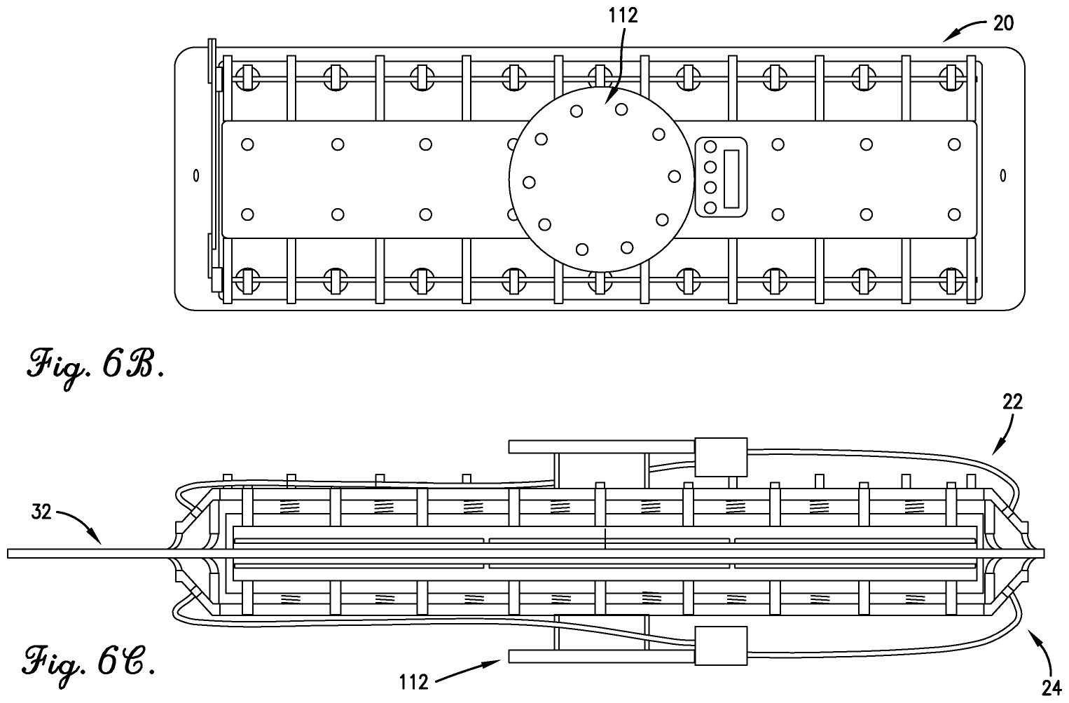

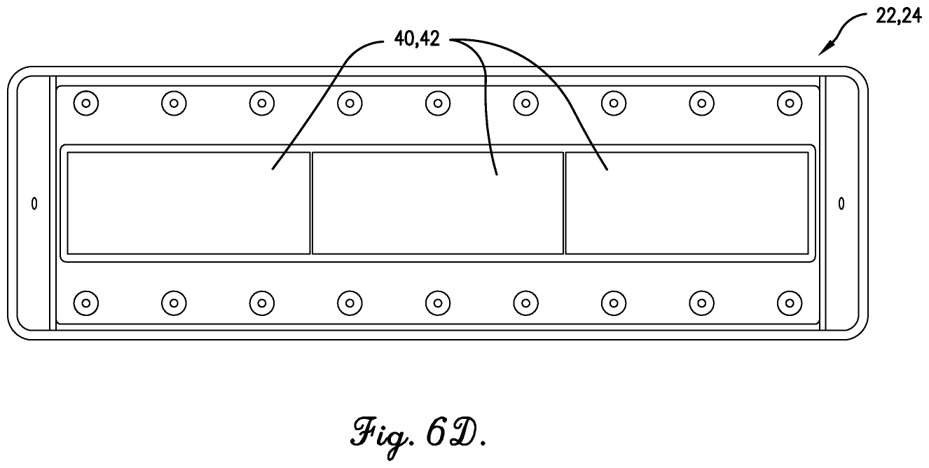

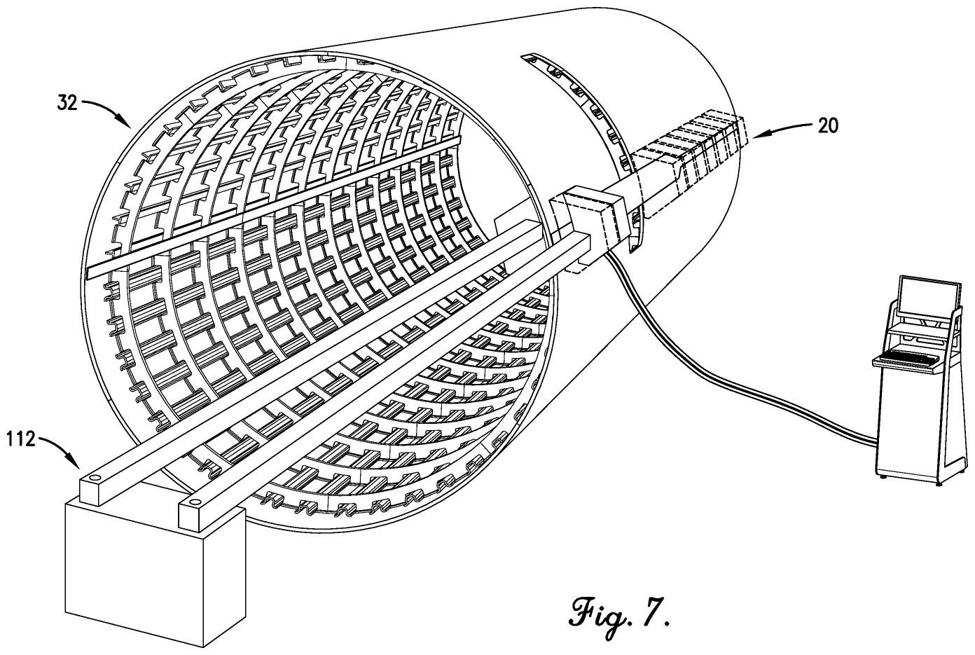

The system 20 may be configured to perform sequential welding or continuous full length welding. Referring also to FIGS. 6A-D and 7, in sequential welding, an arm, rail, or other robot or mover 112 may move the system 20 along the joint 30 and the system 20 may sequentially weld overlapping portions of the joint 30 until the full length of the weld is achieved. In one implementation, this may employ multiple instances or elongated versions of the described components of system, such as the multiple contour plates 40,42 seen in FIG. 6D. Coordination between sides 22,24 may be achieved from an open end of the structure 32. In one implementation, such a system 20 may provide an approximately thirty minute weld time with eight watts per square inch on each side for each increment, and require approximately eight to ten amperes at four hundred eighty volts.

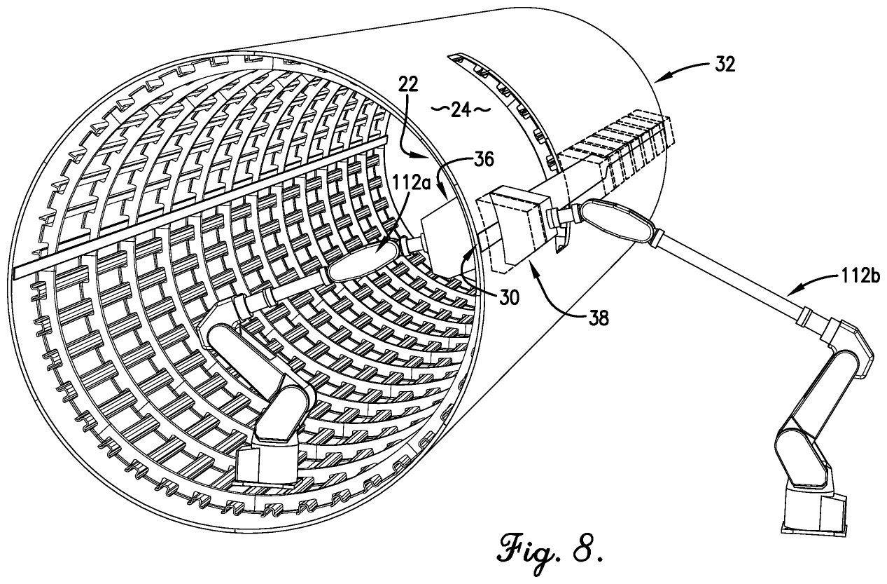

Referring also to FIG. 8, an alternative configuration for sequential welding is shown in which the welding heads 36,38 are independently supported by robotic arms 112A,112B on opposite sides 22,24 of the structure 32 while moving along the joint 30 and welding in an overlapping sequence of welds. The same welding heads may be used for wide or narrow welds, though certain components, such as the heaters, may be replaced to better accommodate particular desires or needs.

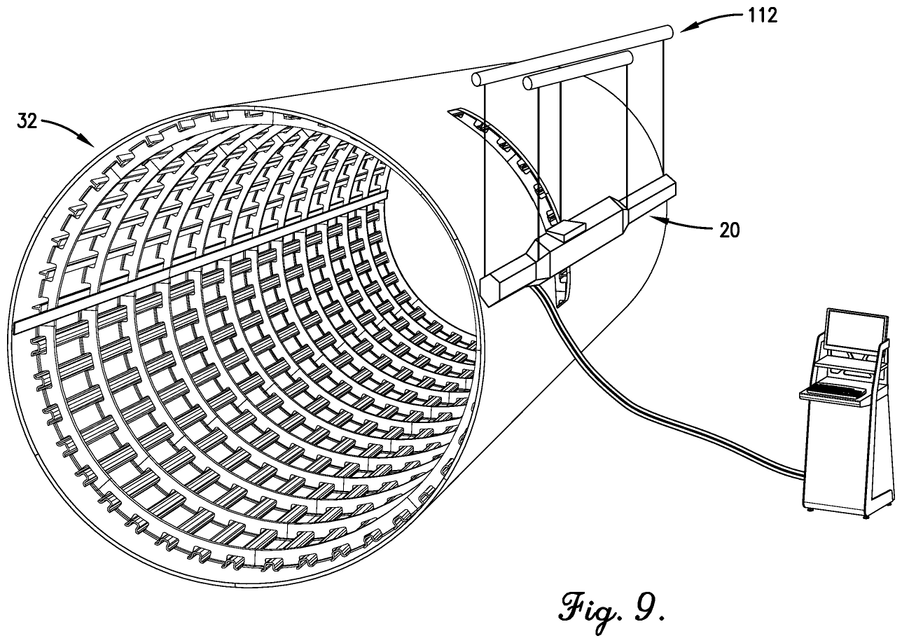

Referring also to FIG. 9, in continuous full length welding, the system 20 may clamp and weld the entire length of the joint at once, with no required movement along that length. Coordination between sides may be achieved through an opening (e.g., a door) in the structure 32. Relatedly, a gap may be provided in the heaters for such an opening where no welding occurs. In one implementation, such a system may provide an approximately thirty minute weld time with eight watts per square inch on each side, and require approximately forty amperes at four hundred eighty volts.

In one embodiment, the system may be provided in a hand-held form. In one implementation, the two welding heads may each be provided in hand-held form, wherein a first operator with the first hand-held welding head is located on the first side of the structure, and a second operator with the second hand-held welding head is located on the second side of the structure. In hand-held form, the system may be used for sequential welding or, for relatively short welds, for continuous full length welding. Referring to FIG. 8, for example, a hand-held configuration may involve replacing the robotic arms with handles for operators to grip.

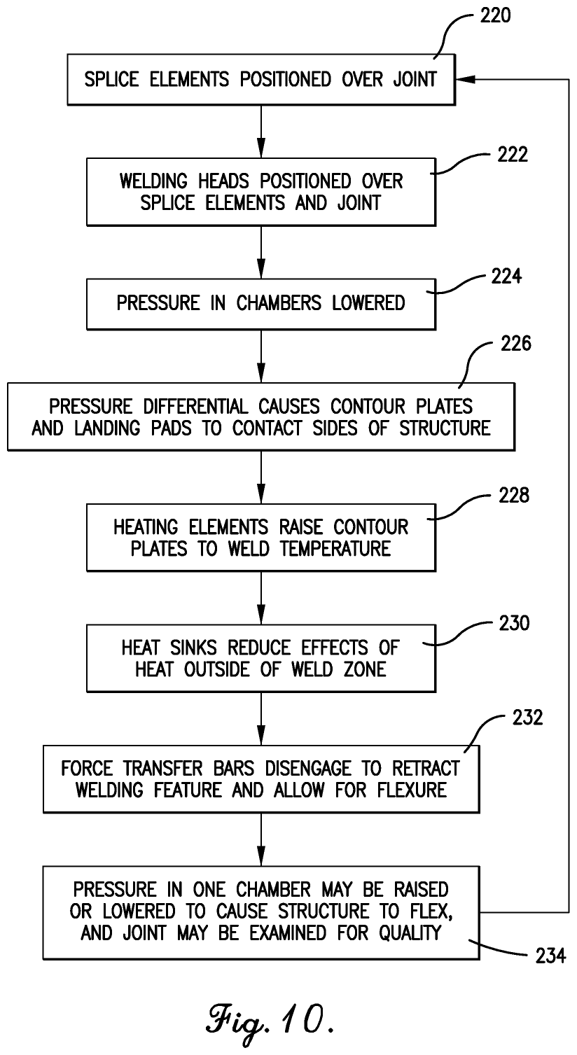

Referring also to FIG. 10, in operation, an embodiment of the system 20 may function substantially as follows. A splice element 36 may be positioned over the joint 30 on one or both sides 26,28 of the structure 32, and secured or “tacked” in place, as shown in 220. The welding heads 22,24 may be positioned over the splice piece 26 and the joint 30 on each side 26,28 of the structure 32, as shown in 222. The actuators 60 may be placed in a first position, in which the extendable landing pads 56 are not extended. Vacuum may be applied to evacuate air from and lower the pressure in the chambers 84,86 defined by each housing 36,38 and its respective side 26,28 of the structure 32, as shown in 224. Atmospheric pressure against the exterior surfaces of the housings 36,38 may cause the landing pads 56,58 and contour plates 40,42 on each side of the structure 32 to contact the structure 32 at substantially the same time, as shown in 226. In the case in which the splice piece 36 is proud of the surfaces 26,28, it may be compressed by the contour plate 40,42 before the landing pads 56,58 contact.

The heaters 44,46 may raise the temperature of the contour plates 40,42 to the weld temperature, as shown in 228. If only the second welding head 24 has a heater 46, then the OML contour plate 46 may press the splice piece 36 into the respective side 28 of the structure 32 and the heater 46 may melt the structure 32 to full depth. If both welding heads 24,26 have heater 44,46, the heater 44,46 may each melt the structure to one-half depth. The heat sinks 68,70 may continuously act to prevent melting or otherwise reduce the effects of heat outside of the weld zone, as shown in 230. The actuators 60 may transition to a second position so that the extendable landing pads 56 are extended and pushing against the IML side 26 of the structure 32.

The contour plates 40,42 may compress the structure 32 against each other under intensified vacuum pressure. The weld temperature may be maintained during cooldown to optimize crystallinity. Following welding and cooldown, the placement of the welding heads 22,24 may be confirmed and the lower pressures may be raised. For sequential welding, the system 20 may be moved an overlapping distance along the joint 30 and the process repeated.

As discussed, changing pressure in one of the chambers 84,86 may be used to create a flex or distortion force on the welded joint 30, and the amount of flexure or distortion may be measured and used as a metric for evaluating the quality of the welded joint 30. In one implementation, this may be accomplished by removing one of the welding heads and leaving the other in place. It may be desirable with sequential welding to validate each weld before moving to the next. In one implementation of the this process, the force transfer bars 80,82 may be disengaged to retract the welding features, as shown in 232 and seen in FIG. 5. A known pressure differential may be applied to flex or distort the joint, as shown in 234. The sensors 100 may provide feedback regarding any deflection of the structure 32. The results of such testing may be compared to the results of other destructive or non-destructive testing.

Although the invention has been described with reference to the one or more embodiments illustrated in the figures, it is understood that equivalents may be employed and substitutions made herein without departing from the scope of the invention as recited in the claims.

Having thus described one or more embodiments of the invention, what is claimed as new and desired to be protected by Letters Patent includes the following:

1. A system for welding a joint of a structure, the system comprising:
a first welding head positioned over the joint on a first side of the structure, the first welding head comprising:
a first housing defining a first chamber between the first housing and the first side, the first chamber comprising a first lower pressure than atmospheric pressure such that a first pressure differential forces the first welding head against the first side,
a first contour plate located in the first chamber and compressing the joint on the first side, wherein the first contour plate is smaller by a first factor than the first housing so that the first pressure differential caused by the first lower pressure forces the first contour plate against the joint with a first force that is greater than atmospheric pressure; and
a second welding head positioned over the joint opposite the first welding head on a second side of the structure, the second welding head comprising:
a second housing defining a second chamber between the second housing and the second side, the second chamber comprising second lower pressure than atmospheric pressure such that a second pressure differential forces the second welding head against the second side,
a second contour plate located in the second chamber compressing the joint on the second side, wherein the second contour plate is smaller by a second factor than the second housing so that the second pressure differential caused by the second lower pressure forces the second contour plate against the joint with a second force that is greater than atmospheric pressure, and
a heater located in the second chamber and heating the second contour plate to a welding temperature to weld the joint.

2. The system of claim 1, wherein the structure is a thermoplastic composite structure.

3. The system of claim 1, wherein the first lower pressure is no more than five percent different from the second lower pressure.

4. The system of claim 1, wherein the first contour plate has a different area than the second contact plate.

5. (canceled)

6. The system of claim 1, wherein the heater located in the second chamber and heating the second contour plate is a second heater, and the system further comprising a first heater located in the first chamber and heating the first contour plate to the welding temperature.

7. The system of claim 1, further comprising:
a first splice piece located in the first chamber and positioned between the joint and the first contour plate so as to be welded over the joint; and
a second splice piece located in the second chamber and positioned between the joint and the second contour plate so as to be welded over the joint.

8. The system of claim 1, further comprising an aligner aligning the first and second housings on opposite sides of the structure.

9. The system of claim 1, further comprising:
a first compressible seal maintaining the first lower pressure in the first chamber; and
a second compressible seal maintaining the second lower pressure in the second chamber.

10. The system of claim 1, further comprising:
a first landing pad extending between the first housing and the first side of the structure and reducing deformation of the structure; and
a second landing pad extending between the second housing and the second side of the structure and reducing deformation of the structure.

11. The system of claim 10, further comprising an actuator moveable between a first position in which the actuator exerts a force on an end of the first landing pad, and a second position in which in which the actuator does not exert the force on the end of the first landing pad.

12. The system of claim 1, further comprising:
a first vacuum connection located on the first housing and connected to a vacuum source to create the first lower pressure in the first chamber; and
a second vacuum connection located on the second housing and connected to the vacuum source to create the second lower pressure in the second chamber.

13. The system of claim 1, further comprising:
a first heat sink located in the first chamber and in physical contact with the first side to remove heat from the first side; and
a second heat sink located in the second chamber in physical contact with the second side to remove heat from the second side.

14. The system of claim 1, further comprising:
a first insulation spacer located in the first chamber and controlling a transfer of heat from the first heater; and
a second insulation spacer located in the second chamber and controlling a transfer of heat from the second heater.

15. The system of claim 1, further comprising:
a first transfer bar located in the first chamber and extending with a first adjustable length between the first housing and the first contour plate and transferring a force of the first pressure differential to the first contour plate; and
a second transfer bar located in the second chamber and extending with a second adjustable length between the second housing and the second contour plate and transferring a force of the second pressure differential to the second contour plate.

16. The system of claim 1, further comprising:
a first vacuum regulator coupled with the first chamber and independently controlling the first lower pressure; and
a second vacuum regulator coupled with the second chamber and independently controlling the second lower pressure.

17. The system of claim 1, further comprising:
a first actuator extending between the first housing and the first contour plate and selectively advancing and withdrawing the first contour plate relative to the first side of the structure; and
a second actuator extending between the second housing and the second contour plate and selectively advancing and withdrawing the second contour plate relative to the second side of the structure.

18. The system of claim 1, further comprising:
a first arm coupled with the first welding head and moving the first welding head along the joint so as to remain aligned with the second welding head; and
a second arm coupled with the second welding head and moving the second welding head along the joint, wherein the system welds the joint in successive overlapping sections.

19. A system for welding a joint of a thermoplastic composite structure, the system comprising:
a first welding head positioned over the joint on a first side of the thermoplastic composite structure, the first welding head comprising:
a first housing defining a first chamber between the first housing and the first side, the first chamber comprising a first lower pressure than atmospheric pressure such that a first pressure differential forces the first welding head against the first side with a first force,
a first contour plate located in the first chamber and compressing the joint on the first side,
a first transfer bar located in the first chamber and extending with a first adjustable length between the first housing and the first contour plate and transferring the first force of the first pressure differential to the first contour plate, and
a first heater located in the first chamber and heating the first contour plate to a welding temperature;
a second welding head positioned over the joint opposite the first welding head on a second side of the thermoplastic composite structure, the second welding head comprising:
a second housing defining a second chamber between the second housing and the second side, the second chamber comprising second lower pressure than atmospheric pressure such that a second pressure differential forces the second welding head against the second side with a second force,
a second contour plate located in the second chamber compressing the joint on the second side,
a second transfer bar located in the second chamber and extending with a second adjustable length between the second housing and the second contour plate and transferring the second force of the second pressure differential to the second contour plate, and
a second heater located in the second chamber and heating the second contour plate to the welding temperature to weld the joint.

20. A system for welding a joint of a thermoplastic composite structure, the system comprising:
a first welding head positioned over the joint on a first side of the thermoplastic composite structure, the first welding head comprising:
a first housing defining a first chamber between the first housing and the first side, the first chamber comprising a first lower pressure than atmospheric pressure such that a first pressure differential forces the first welding head against the first side,
a first vacuum connection located on the first housing and connected to a vacuum source to create the first lower pressure in the first chamber,
a first contour plate located in the first chamber and compressing the joint on the first side, wherein the first contour plate is smaller by a first factor than the first housing so that the first pressure differential forces the first contour plate against the joint with a first force that is greater than atmospheric pressure,
a first transfer bar located in the first chamber and extending with a first adjustable length between the first housing and the first contour plate and transferring the first force of the first pressure differential to the first contour plate, and
a first heater located in the first chamber and heating the first contour plate to a welding temperature;
a second welding head positioned over the joint opposite the first welding head on a second side of the thermoplastic composite structure, the second welding head comprising:
a second housing defining a second chamber between the second housing and the second side, the second chamber comprising second lower pressure than atmospheric pressure such that a second pressure differential forces the second welding head against the second side,
a second vacuum connection located on the second housing and connected to the vacuum source to create the second lower pressure in the second chamber,
a second contour plate located in the second chamber compressing the joint on the second side, the second contour plate is smaller by a second factor than the second housing so that the second pressure differential forces the second contour plate against the joint with a second force that is greater than atmospheric pressure,
a second transfer bar located in the second chamber and extending with a second adjustable length between the second housing and the second contour plate and transferring the second force of the second pressure differential to the second contour plate, and
a second heater located in the second chamber and heating the second contour plate to the welding temperature; and
an aligner aligning the first and second housings on the first and second sides of the structure.
